(19) United States
(12) Patent Application Publication
(10) Pub. No.: US 2026/0202661 A1
(43) Pub. Date: Jul. 16, 2026

(54) METHOD AND APPARATUS FOR CONTROLLING A DRIVE OF A MULTI-AXIS MICROSCANNER SYSTEM, AND MICROSCANNER SYSTEM

(71) Applicant: OQMENTED GMBH, Itzehoe (DE)

(72) Inventors: Felix Christoph TIEDE, Hamburg (DE); Marco MEOLA, Kiel (DE)

(21) Appl. No.: 19/138,168

(22) PCT Filed: Dec. 6, 2023
(86) PCT No.: PCT/EP2023/084625

§ 371 Date: Jun. 12, 2025

(30) Foreign Application Priority Data
Dec. 13, 2022 (DE) 10 2022 133 117.2

(51) Int. Cl. G02B 26/10

(52) U.S. Cl. CPC G02B 26/101

(57) ABSTRACT

The invention relates to a method for controlling a drive of a multi-axis microscanner system having a first oscillation axis and a second oscillation axis which runs in particular orthogonally, not in parallel, with respect thereto, the method comprising: generating reference information which defines a simultaneous reference oscillation, which is in particular harmonic for each oscillation axis, about the first and the second oscillation axis so that the reference information establishes, for each of the first and the second oscillation axes, an associated reference frequency and an associated reference phase of the reference oscillation; activating a drive device for the microscanner system such that the drive device is prompted to drive a first, in particular harmonic, rotational oscillation of a deflection element of the microscanner system about the first oscillation axes by means of excitation at a first drive frequency and to drive a second, in particular harmonic, rotational oscillation of a deflection element, carried out simultaneously with the first oscillation, about the second oscillation axis by means of excitation at a second drive frequency. The drive device is activated such that, with regard to each of the oscillations, the particular drive frequency and/or drive phase thereof is or are varied over time by means of a controller such that, with respect to the oscillation axis associated with the particular oscillation, deviation of the particular oscillation from the reference oscillation in respect of frequency and phase is counteracted.

The present invention relates to a method and device for controlling a drive of a multi-axis, in particular two-axis, microscanner system as well as a microscanner system having such a device for controlling its drive.

Microscanners, which are also referred to in technical terms in particular as “MEMS scanners”, “MEMS mirrors”, or “micromirrors”, or in English in particular as “microscanner” or “micro-scanning mirror” or “MEMS mirror”, are micro-electro-mechanical systems (MEMS) or more specifically micro-opto-electro-mechanical systems (MOEMS) from the class of micromirror actuators for dynamic modulation of electromagnetic radiation, in particular of visible light. Depending on the design, the modulating movement of an individual mirror can be translational or rotational about at least one oscillation axis. In the first case, a phase-shifting effect is achieved, and in the second case deflection of the incident electromagnetic radiation is achieved. Furthermore, microscanners and microscanner systems based thereon are considered in which the modulating movement of an individual mirror is also rotational, at least in addition. In microscanners, the modulation is typically generated via a single mirror for each MEMS-element (microscanner), in contrast to mirror arrays, in which the modulation of incident light occurs via the interaction of multiple mirrors on a single MEMS-element.

Microscanners may thus be used in particular to deflect electromagnetic radiation in order to modulate an electromagnetic beam incident thereon with respect to its deflection direction by means of a deflection element (“mirror”). This can be used in particular to create a Lissajous projection of the beam into an observation field or projection field based on a respective harmonic oscillation about a first oscillation axis and a second oscillation axis of the deflection element which is non-parallel, in particular orthogonal, thereto. For example, imaging sensory tasks can thus be achieved or display functionalities can be implemented. In addition, such microscanners can also be used to irradiate materials in an advantageous manner and in particular to process them. Other possible applications are in the area of lighting or illuminating certain open or closed spaces or areas of spaces using electromagnetic radiation, for example in the context of headlight applications.

In many cases, microscanners consist of a mirror plate (deflection plate) that is suspended laterally on elastically stretchable springs. A distinction is made between single-axis mirrors, which should preferably only be suspended so as to be rotatable about a single axis, and two-axis and multi-axis mirrors, in which rotations, in particular rotational oscillations, are possible about a corresponding number of different axes, in particular simultaneously.

A microscanner system for deflecting an electromagnetic beam can thus in particular have a two-axis microscanner, i.e., a microscanner with two different, non-parallel, in particular mutually orthogonal, oscillation axes or a combination of multiple individual, in particular two, single-axis microscanners which are arranged such that the incident beam can be deflected in succession by the various individual microscanners of the microscanner system, in order to generate a bi-dimensional deflection pattern, in particular a Lissajous figure. In a microscanner system with a combination of two or three single-axis microscanners, their non-parallel oscillation axes can be orthogonal to each other, particularly in pairs.

Both in the case of imaging sensors and in the case of a display function, a multi-axis microscanner is used to deflect electromagnetic radiation such as a laser beam or a shaped beam from any other source of electromagnetic radiation at least in two dimensions, for example horizontally and vertically, in order to thus scan or illuminate an object surface within an observation field. In particular, this can be done in such a way that the scanned laser beam sweeps over a rectangular surface on a projection surface in the projection field. In these applications, microscanner systems having at least one two-axis microscanner or having multiple, in particular two, single-axis microscanners connected in succession in the optical path are used. The wavelength range of the radiation to be deflected can in principle be selected from the entire spectrum of short-wave UV radiation, through the VIS range, NIR range, IR range, FIR range up to long-wave Terahertz and radar radiation.

Especially in so-called Lissajous microscanners or Lissajous microscanner systems, two non-parallel, in particular mutually orthogonal oscillation axes are operated simultaneously, in particular in resonance or close to the resonance angular frequency ω₀ relative to the respective oscillation axis (i.e. in a resonance range of finite resonance width ω₀±δω) for each oscillation axis, in order to generate a trajectory of the deflected radiation in the form of a Lissajous figure by means of a respective harmonic oscillation for each oscillation axis. In this way, large amplitudes can be achieved in both axes.

A deflection device for a projection system for projecting Lissajous figures onto an observation field is known from EP 2 514 211B1, which device is designed to deflect a light beam around at least a first and a second deflection axis to generate Lissajous figures.

The object of the present invention is to further improve the operation of Lissajous microscanners with regard to high achievable image quality, in particular with regard to a high degree of homogeneity during illumination of the observation field.

This object is achieved according to the teaching of the independent claims. Various embodiments and developments of the invention are the subject matter of the dependent claims.

A first aspect of the solution presented herein relates to a method for controlling a drive of a multi-axis microscanner system having a first oscillation axis and a second oscillation axis running non-parallel, in particular orthogonally, thereto. The method comprises:
(i) generating reference information which defines a simultaneous reference oscillation, which is in particular harmonic for each oscillation axis, about the first and the second oscillation axis so that the reference information establishes, for each of the first and the second oscillation axes, an associated reference frequency and an associated reference phase of the reference oscillation;
(ii) controlling a drive device for the microscanner system in such a way that the drive device is caused
   (ii-1) to drive a first, in particular harmonic, rotational oscillation of a deflection element (e.g. mirror) of the microscanner system about the first oscillation axes by means of an excitation at a first drive frequency, and
   (ii-2) to drive a second, in particular harmonic, rotational oscillation of a deflection element (e.g. mirror of the microscanner system) carried out simultaneously with the first oscillation about the second oscillation axis by means of an excitation at a second drive frequency.

The drive device is controlled in such a way that, with regard to each of the oscillations, the respective drive frequency and/or drive phase thereof is/are varied over time by means of a controller in such a way that, with respect to the oscillation axis associated with the respective oscillation, a deviation of the respective oscillation from the reference oscillation in terms of frequency and phase is counteracted.

The deflection element performing the first oscillation and the deflection element performing the second oscillation can be either identical (multi-axis oscillation of a deflection element) or different (e.g. two deflection elements each oscillating about a single axis).

The drive device can in particular have a separate drive for each oscillation axis, which can in particular have one or more actuators, in particular piezo actuators. Such actuators can in particular be arranged on or in a suspension of the deflection element(s) in order to excite the respective deflection element to oscillate by exerting force on the suspension.

The first and second drive frequencies can in particular also be defined as circular frequencies.

In the method according to the first aspect, a reference trajectory is thus indirectly defined on the basis of the definition of the reference oscillation, which reference trajectory results when the drive device is controlled in such a way that it causes the microscanner system to carry out the reference oscillation and, in doing so, to deflect an incident electromagnetic beam into an observation field associated with the microscanner system by means of its at least one deflection element which oscillates rotationally about its respective oscillation axis(es) in accordance with the reference oscillation.

The control then ensures that the actual oscillations follow the actually occurring trajectory at least to a good approximation (depending in particular on the quality of the control and the inertia of the microscanner system) of the defined reference trajectory by varying the drive frequencies and/or drive phases. The control can therefore also be referred to as “trajectory following control”. If the reference trajectory is adjusted by means of a correspondingly suitable definition of the reference oscillation in such a way that an advantageous illumination of the observation field is achieved, then the trajectory tracking control can counteract a change in this advantageous illumination even if, for example, due to temperature changes, ambient pressure changes, radiation pressure changes and/or other influences on the microscanner system that change its natural or resonant frequencies, a change in the illumination, in particular towards less advantageous trajectories, would result without such control. An advantageous illumination can be characterized in particular by a high degree of homogeneity and/or a high line density (i.e. with a high density of adjacent lines of the trajectory of the electromagnetic beam deflected by the microscanner system into the observation field). Unlike an independent control of each oscillation axis or oscillation, the method according to the first aspect provides for a dependency of the controlled oscillations, which results from the fact that both oscillations as a whole are controlled in the sense of the above-mentioned trajectory following control on the reference trajectory caused by both oscillations at the same time.

The method can therefore be used particularly advantageously in applications in the field of projection displays, where a consistently high image quality of the projected image is required even when external factors influencing the projection change.

The term “reference information” as used herein means information that defines an associated reference frequency and an associated reference phase of the reference oscillation for each of the first and second oscillation axes. This information can be in particular analog or digital form and can be made available in particular via a correspondingly modulated signal, in particular for each oscillation axis. In particular, the reference information can be represented by two separate signals for each oscillation axis, one for the reference frequency and one for the reference phase.

A “deflection element” as defined in the invention is understood in particular as a body which has a reflective surface (mirror surface) that is smooth enough that reflected electromagnetic radiation, such as visible light, retains its parallelism under the law of reflection and an image can thus be reproduced. The roughness of the mirror surface has to be less than approximately half the wavelength of the electromagnetic radiation. In particular, suitable roughness has a mean roughness value Rₐ≤1000 nm, where Rₐ≤100 nm is preferred, and Rₐ<5 nm is particularly preferred. The mean roughness value indicates the mean distance of a measuring point on the surface to the midline. The mean roughness value corresponds to the arithmetic mean of the deviation of absolute value from the centerline and is defined in particular in the DIN EN ISO 4287:2010 standard.

The deflection element can in particular be designed as a mirror plate having at least one mirror surface or can include such a mirror plate. In particular, the mirror surface itself can consist of a different material, for example of a metal, which is in particular deposited, than the other body of the deflection element.

A “oscillation axis” or the synonym “axis” as defined in the invention is to be understood in particular as an axis of rotation (rotation axis) of a rotational movement. It is a straight line that defines or describes a rotation or turn.

A “Lissajous projection” (and variations thereof) as defined in the invention is to be understood in particular as scanning of an observation field with the aid of electromagnetic radiation, which is effectuated by at least two orthogonal harmonic oscillations (oscillations) of a deflection device deflecting the radiation into the field of observation, in particular a single deflection element or a combination of at least two deflection elements.

The term “piezo element” (and variations thereof), as defined in the inventions is to be understood as a component that exploits the (direct) piezoeffect to produce an electrical voltage when a mechanical force is applied (“piezosensor”), or uses the inverse piezoeffect to perform a mechanical movement by applying an electrical voltage (“piezoactuator” or equivalent “piezo-actuator”). In particular, ferroelectric materials are always piezoelectric at the same time.

As possibly used herein, the terms “comprises,” “contains,” “includes,” “encompasses,” “has,” “with,” or any other variant thereof are intended to cover non-exclusive inclusion. For example, a method or a device that comprises or has a list of elements is not necessarily restricted to these elements, but may include other elements that are not expressly listed or that are inherent to such a method or such a device.

Furthermore, unless expressly stated to the contrary, “or” refers to an inclusive or and not to an exclusive “or”. For example, a condition A or B is met by one of the following conditions: A is true (or present) and B is false (or absent), A is false (or absent) and B is true (or present), and both A and B are true (or present).

The terms “a” or “an” as used herein, are defined in the meaning of “one or more”. The terms “another” and “a further” and any other variant thereof are to be understood to mean “at least one other”.

The term “plurality” as possibly used herein is to be understood to mean “two or more”.

The terms “first,” “second,” “third,” and similar terms in the specification and claims are used to distinguish between similar or otherwise like-named elements and are not necessarily descriptive of a sequential, spatial, or chronological order. It should be understood that the terms so used are interchangeable under appropriate circumstances, and that the embodiments of the solution described herein may operate in different orders than those described or illustrated herein.

The term “configured” or “set up” to perform a specific function (and respective modifications thereof), possibly used herein, is to be understood to mean that the corresponding device or component thereof is already provided in a design or setting in which it can execute the function or that it is at least adjustable-namely configurable so that it can execute the function after corresponding adjustment. The configuration can take place, for example, via a corresponding setting of parameters of a process course or of switches or the like for activating or deactivating functionalities or settings. In particular, the device can have multiple predetermined configurations or operating modes, so that the configuration can be carried out by selecting one of these configurations or operating modes.

Preferred exemplary embodiments of the method are described hereinafter, which in each case, unless expressly excluded or technically impossible, can be combined as desired with one another and with other aspects of the present solution, which will be described in the following.

In some embodiments, the drive device is controlled in such a way that the driving of the first oscillation is pre-controlled with the first drive frequency and/or the driving of the second oscillation is pre-controlled with the second drive frequency before the respective drive frequency and/or drive phase of the respective oscillation is varied over time within the scope of the control. In this way, the first and second oscillations are initially excited according to the reference oscillation. This can be done in particular until a steady state of the oscillations is reached. In the steady state, this results, at least essentially, in a trajectory that corresponds to the reference trajectory corresponding to the reference oscillation. Over time, the control then acts to maintain the reference trajectory (within the scope of the control's capabilities) even when disturbances occur, such as changes in the natural or resonance frequencies of the oscillations (e.g. due to temperature changes).

In some embodiments, for at least one oscillation axis, the temporal variation of the drive frequency and/or the drive phase of the oscillation associated with this oscillation axis takes place within the framework of the control as a function of measurement information, in particular a measurement signal carrying the measurement information, which represents a measured actual phase of the oscillation about this oscillation axis. The actual phase or a variable dependent thereon, from which the actual phase can be inferred, can be measured in particular by means of one or more position sensors, in particular piezo sensors, which are configured as a whole to detect a deflection of the deflection element of the microscanner system associated with the oscillation axis for each oscillation axis. Overall, the control can be implemented using a phase locked loop (PLL).

In some embodiments, the temporal variation of the drive frequency and/or drive phase of the oscillation associated with this oscillation axis takes place within the scope of the control specifically as a function of a phase difference between the actual phase of the oscillation represented by the measurement information and the corresponding phase of the reference oscillation with respect to the oscillation axis associated with the oscillation.

In some embodiments, the method further comprises: (i) for the at least one oscillation axis: monitoring the phase difference between the drive phase and the actual phase of the oscillation associated with this oscillation axis; and (ii) if a change in the phase difference is detected for this oscillation axis as part of the monitoring, varying the respective drive frequencies for the first oscillation and for the second oscillation as part of the control by raising or lowering them by a factor that is the same for both oscillations, wherein the factor is selected such that, with regard to the at least one oscillation axis, a drift of the angular frequency of the associated oscillation out of a defined resonance range (ω₀±δω) of the angular frequency of the oscillation is counteracted, in particular such a drift is completely prevented. The deviation δω from the resonant frequency ω₀ can in particular be defined as δω=k·ω₀ with |k|≤0.1, in particular with |k|≤0.05.

Here, the two oscillations are thus coupled with regard to their control via the common factor. As a result, this common factor in harmonic oscillations determines a repetition rate of a Lissajous figure-shaped trajectory of the deflected beam determined by the two oscillations (more precisely their oscillation parameters amplitude, frequency and phase). The control thus allows compensation of external disturbances of the oscillations (e.g. due to temperature increases) while maintaining the set or previous Lissajous figure-shaped trajectory. In particular, dynamically changing the repetition rate enables resonant operation over a wide range of parameter fluctuations in the system. This makes operation in a wide temperature range possible, for example.

In some of these embodiments, the control is carried out in such a way that the common factor is determined as a function of one of the following variables:
(i) detected phase difference between the drive phase and the actual phase of only one previously selected oscillation;
(ii) mean value of the respective phase differences detected between the respective drive phase and the respective actual phase of the first oscillation on the one hand and the second oscillation on the other hand;
(iii) detected phase difference between the drive phase and the actual phase of only one of the oscillations, wherein this oscillation is dynamically selected from the two oscillations during control as the smaller of the phase differences last detected over time.
Case (i) represents a particularly simple possibility to implement, in particular using a PLL, in which only one oscillation is considered for determining the factor. The phase difference of the other oscillation, however, can be ignored, so it does not even need to be determined.
Case (ii) represents a particularly balanced possibility in which the phase differences of both oscillations are taken into account equally, thus allowing at least a good approximation to an optimal adaptation of the factor. This ensures an average resonant and efficient operation of both oscillations.
Case (iii) represents a particularly stability-promoting possibility. It is controlled relative to the more critical (usually the smaller) of the two phase differences. This dynamically switches which of the two oscillations is used as the decisive factor for the control. This mode promises the greatest stability especially when the oscillations do not have a restoring force that is linear with the deflection according to Hooke's law, but the restoring force has at least (also) a cubic term (Duffing oscillator). In such an oscillator, instability of the oscillation can generally occur depending on the drive frequency and/or drive phase, so that unwanted jumps can occur at certain points of the amplitude/drive frequency characteristic curve when the drive frequency is varied. Case (iii) counteracts the risk of such jumps by adjusting the drive frequency within the control system in such a way that the jumps are avoided.

In some embodiments, in particular also for the reasons stated in case (iii), in the context of the control in the steady state of the first oscillation, the first drive phase is limited such that it leads the measured actual phase of the first oscillation by less than 90°, in particular by 85° or less; and/or in the steady state of the second oscillation, it limits the second drive phase such that it leads the measured actual phase of the second oscillation by less than 90°, in particular by 85° or less. This is done against the background that in the Duffing oscillator, the corresponding oscillation equation shows that the largest amplitude is to be expected for a drive phase that leads the actual phase by 90°, but the range above 90° is unstable.

In some embodiments, within the scope of the control with respect to at least one of the oscillations, a correction variable for the drive phase of the oscillation, defined via at least one adjustable parameter, is included in the determination of a control variable of the control for this oscillation. The correction value can be used in particular to correct systematic phase measurement errors when determining the actual phase. This allows for even more precise trajectory following control to be implemented.

In some embodiments, in the context of the control with respect to at least one of the oscillations, a phase shift dependent on a dead time of an image processing process for images to be imaged by means of the microscanner system is included in the determination of a control variable of the control for this oscillation. In this way, it can be achieved that, despite the finite dead time, a modulation of the electromagnetic beam used for imaging or projection, e.g. laser beam, is timed to match the actual oscillation movement of the deflection element(s) of the microscanner system in such a way that an undistorted or undisturbed image can be projected into the observation field.

A second aspect of the solution presented herein relates to a device, in particular an electrical (in particular electronic) circuit, for controlling a drive of a multi-axis microscanner system having a first oscillation axis and a second oscillation axis running non-parallel thereto. The device comprises:
(i) a reference information source for generating reference information which defines a simultaneous reference oscillation, which is in particular harmonic for each oscillation axis, about the first and the second oscillation axis so that the reference information establishes, for each of the first and the second oscillation axes, an associated reference frequency and an associated reference phase of the reference oscillation;
(ii) a control device for generating control signals for controlling a drive device of the microscanner system in order to cause the microscanner system, by means of the drive device controlled by means of the control signals,
   (ii-1) to drive a first rotational oscillation of a deflection element of the microscanner system about the first oscillation axes by means of an excitation at a first drive frequency (ω1), and
   (ii-2) to drive a second rotational oscillation of a deflection element of the microscanner system carried out simultaneously with the first oscillation about the second oscillation axis by means of an excitation at a second drive frequency (ω1).

The control device has a controller and is configured to generate the control signal in such a way that, with respect to each of the oscillations, their respective drive frequency and/or drive phase is/are varied over time by means of the controller in such a way that, with respect to the oscillation axis associated with the respective oscillation, a deviation of the respective oscillation in terms of frequency and phase from the reference oscillation is counteracted.

The device is thus also configured in particular to carry out the method according to the first aspect. Accordingly, one or more of the following variants already explained in relation to the method may also apply to the device: The deflection element performing the first oscillation and the deflection element performing the second oscillation may either be identical (multi-axis oscillation of a deflection element) or different (e.g. two deflection elements each oscillating on a single axis). The drive device can in particular have a separate drive for each oscillation axis, which can in particular have one or more actuators, in particular piezo actuators. Such actuators can in particular be arranged on or in a suspension of the deflection element(s) in order to excite the respective deflection element to vibrate by exerting force on the suspension. The first and second drive frequencies can in particular also be defined as angular frequencies.

In some embodiments, the reference information source is configured to determine the reference frequencies and the reference phases of the reference oscillation depending on at least the following input variables:
(i) a setting parameter common to both oscillation axes for setting a repetition rate of the reference oscillation;
(ii) a first setting parameter associated with the first oscillation axis and a second individual setting parameter associated with the second oscillation axis, wherein the shape of the reference oscillation can be determined on the basis of the two individual setting parameters. Thus, the shape of a trajectory (in particular in the form of a Lissajous figure) can also be determined, which results from deflecting an electromagnetic beam, in particular a laser beam, using the deflection element(s) of the microscanner system when the latter executes the reference oscillation.

In some embodiments, the reference information source is further configured to determine the reference frequencies and the reference phases of the reference oscillation additionally as a function of a start phase setting parameter as a further input variable, which defines a start phase for one of the two reference phases of the reference oscillation. This allows in particular the shape of the trajectory to be further influenced. In the case of a Lissajous figure, the angle of rotation of the figure can be set. In particular, a setting can be chosen in which only few or no degeneracies occur, namely the coincidence of several crossing points of the trajectory. This in turn serves the goal of achieving the highest possible image quality, especially line density and/or homogeneity.

In some embodiments, the controller comprises a control loop for controlling the drive frequency and/or the drive phase of the first oscillation and a separate control loop for controlling the drive frequency and/or the drive phase of the second oscillation. This means that each of the two oscillations can be optimally adjusted independently of the other oscillation. However, it is also possible that, as already explained above with regard to embodiments of the method according to the first aspect, the separate control loops are coupled in such a way that the common factor which defines the repetition rate of the reference oscillation is determined as a function of the actual phases of both oscillations and is used to establish both reference frequencies.

In some embodiments, the device itself already comprises the drive device. The device is then already able to define and drive the first and second oscillations of the microscanner system.

In some embodiments, the device is further configured to generate the control signals such that the drive device can be controlled in accordance with one or more of the embodiments of the method according to the first aspect described herein. The features and advantages already explained with regard to the method therefore also apply to the device.

A third aspect of the solution presented herein relates to a microscanner system for deflecting an electromagnetic beam. It features:
(i) a multi-axis microscanner system with two different, non-parallel, in particular mutually orthogonal, oscillation axes or a combination of multiple individual, in particular two, single-axis microscanners which are arranged such that the incident beam can be deflected in succession by the various individual microscanners of the microscanner system, in order to generate a Lissajous figure; and
(ii) a device according to the second aspect for controlling a drive of the micro scanner system by the drive device.

Further advantages, features, and possible applications of the present invention result from the following more detailed description in conjunction with the figures.

In particular

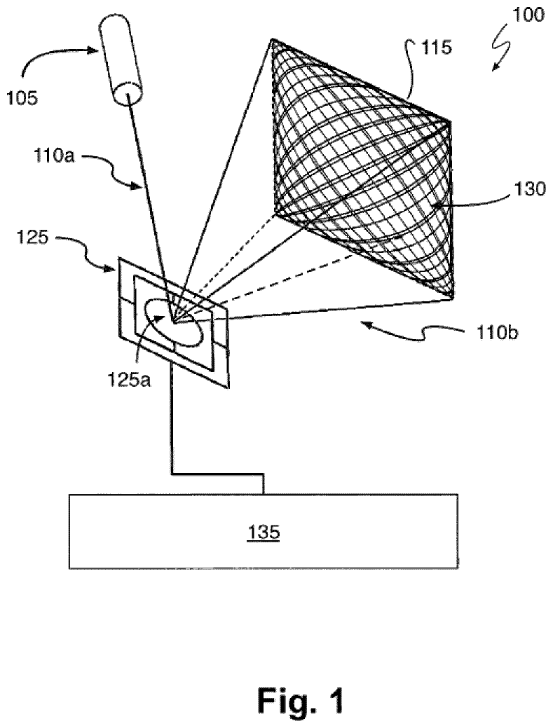

FIG. 1 schematically shows an exemplary embodiment of a projection arrangement with a microscanner system for scanning an observation field with an electromagnetic beam, in particular a laser beam, deflected by the microscanner system;

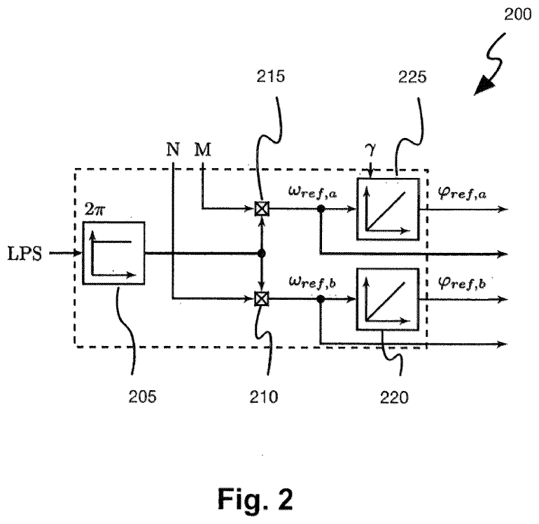

FIG. 2 schematically shows an exemplary embodiment of a signal flow diagram of a reference information source for generating reference information which as a whole defines a simultaneous reference oscillation about a first and a second oscillation axis of a multi-axis microscanner system;

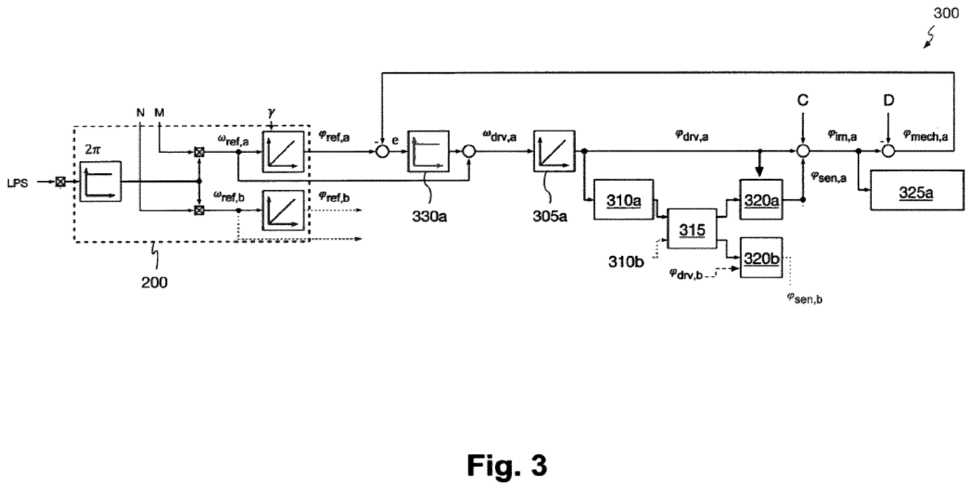

FIG. 3 schematically shows an exemplary embodiment of a signal flow diagram for a trajectory following control for controlling a drive of a multi-axis microscanner system;

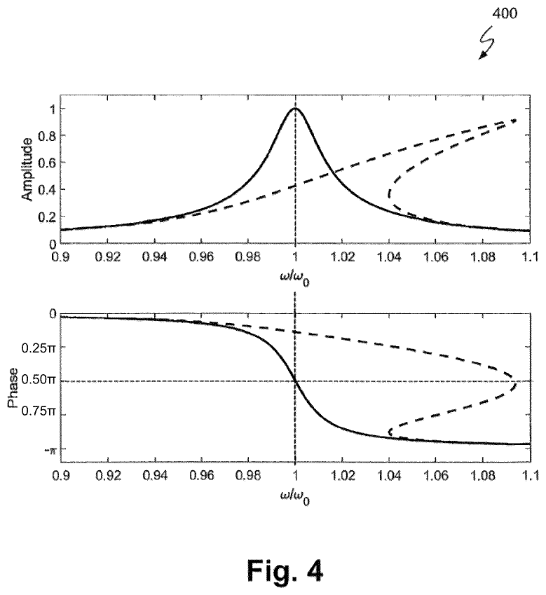

FIG. 4 comparatively shows exemplary amplitude and phase responses of a harmonic oscillator with a restoring force linearly dependent on the deflection, and of a Duffing oscillator; and

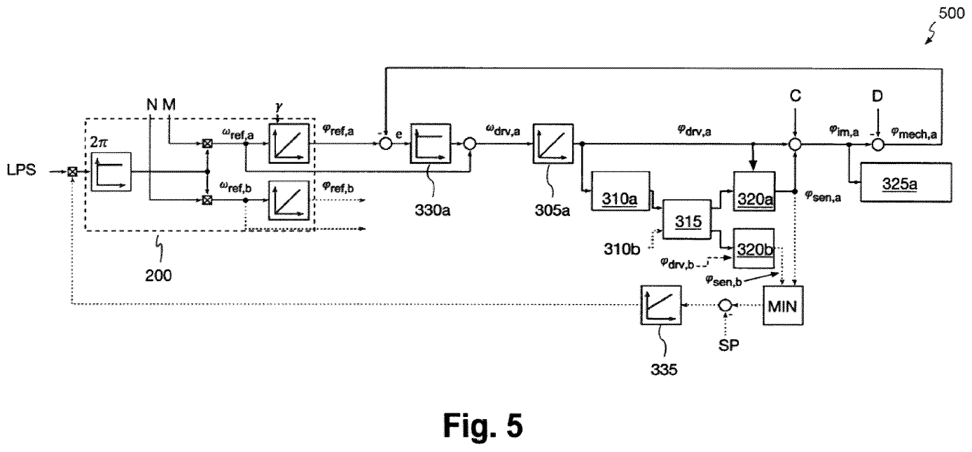

FIG. 5 schematically shows another exemplary embodiment of a signal flow diagram for an extended control with a combined trajectory following control and resonance following control for controlling a drive of a multi-axis microscanner system.

In the figures, like reference numerals designate like, similar or corresponding elements and elements shown in the figures are not necessarily drawn to scale. Rather, the various elements shown in the figures are presented in such a way that their function and general purpose can be understood by those skilled in the art. Connections and couplings, shown in the figures, between functional units and elements can also be implemented as an indirect connection or coupling, unless expressly stated otherwise. Unless specifically stated otherwise, functional units can be implemented in particular as hardware, software or a combination of hardware and software.

FIG. 1 illustrates an exemplary embodiment 100 of a microscanner system comprising a two-axis microscanner 125 for scanning an observation field 115 with a laser beam 110a deflected by the microscanner 125 and a device 135, in particular an electrical circuit, for controlling a drive of the microscanner system 100 with a first oscillation axis and a second oscillation axis running non-parallel, in particular orthogonal, thereto. The microscanner system also has a laser source 105.

The microscanner system 100 is configured such that a laser beam 110a generated by the laser source 105 can be directed indirectly into the observation field by way of mirror imaging on a deflection element (mirror) 125a of the microscanner 125 that oscillates simultaneously about two mutually orthogonal oscillation axes. The laser beam 110 is guided by the oscillating deflection element (mirror) 125a, which is suspended, for example, with an universal joint, in the sense of scanning over the field of observation, thus enabling the illumination of a solid angle. In the example of FIG. 1, this is done by means of a two-dimensional, essentially harmonic oscillation of the deflection element 125a, which leads to a two-dimensional trajectory, in particular a Lissajous figure, 130 as an irradiation pattern. This oscillation can be caused by a suitable, in particular harmonic, control of a drive (not shown in FIG. 1) of the microscanner 125 controlled by the device 135 and results from a superposition of a first oscillation about the first oscillation axis and a second oscillation about the second oscillation axis.

If there is at least one object 115 (such as a projection surface) in the observation field, that at least partially reflects the laser beam 110a on its surface in order to provide a reflected beam 110b, the trace of the reflection point of the laser beam 110b forms on the surface (or in the case of several objects: on several object surfaces) a linear trajectory. The course of the trajectory 130 is essentially due to the oscillating movement of the mirror 125a of the microscanner 125, when the irradiation direction of the laser source 105 is fixed. In FIG. 1, the laser beam 110b is shown as an example for a point in time during the passing through of the irradiation pattern.

FIG. 2 illustrates in the form of a signal flow diagram 200 a reference information source for generating reference information, in particular reference signals, which define a simultaneous reference oscillation about the first and second oscillation axes of a microscanner system, for example the microscanner 125 of the microscanner system 100 from FIG. 1. The reference information respectively defines an associated reference (angular) frequency ω_{ref,a} or ω_{ref,b} and an associated reference phase φ_{ref,a} or φ_{ref,b} of the reference oscillation for the first oscillation axis (indicated by the index “a” in FIG. 2) and for the second oscillation axis (indicated by the index “b” in FIG. 2).

The input variables to the signal flow diagram 200 are (i) a factor LPS, which is associated with both oscillations as a common setting parameter and specifies a repetition rate of the Lissajous figure, e.g. in Hz, (ii) the axis-related individual setting parameters M for the first oscillation axis and N for the second oscillation axis, (iii) and a start phase γ of the oscillation relative to one of the oscillation axes, here by way of example to the first oscillation axis.

In order to obtain the respective angular frequencies ω_{ref,a} and ω_{ref,b} of the two-dimensional reference oscillation (or equivalently of the first and second oscillation), the corresponding individual setting parameter M or N is multiplied by a value resulting from a multiplication 205 of the factor LPS by 2π (110 , 115). By integrating 220 or 225 the respective angular frequency ω_{ref,a} and ω_{ref,b} over time, the reference phases φ_{ref,a} and φ_{ref,b} Of the reference oscillation are obtained. The reference phases φ_{ref,a} and φ_{ref,b} and the reference angular frequencies ω_{ref,a} and ω_{ref,b} represent output variables of the signal flow plan 200 and define the reference oscillation and thus indirectly also a corresponding Lissajous trajectory 130.

The signal flow diagram 200 can be implemented in the device 135 in particular by an electrical, in particular electronic, circuit or computer-implemented using at least one computer program executable on a processor platform or a combination of both.

FIG. 3 shows schematically in the form of a signal flow diagram an exemplary embodiment 300 for a trajectory following control for controlling a drive of a multi-axis microscanner system, such as the microscanner system 100 from FIG. 1. To generate reference information, in particular reference signals that define a two-dimensional reference oscillation, the signal flow diagram 300 contains the signal flow diagram 200 of the reference information source from FIG. 2 as a component.

In addition to the reference information source, the trajectory following control 300 has a control loop for each oscillation axis or each of its respective drives for controlling a drive phase for the respective oscillation axis. In FIG. 3, for reasons of clarity of representation, only the control loop for the first oscillation axis “a” is illustrated, while the control loop for the second oscillation axis “b”, which has the same structure as the control loop for the first oscillation axis, is largely not shown. Therefore, only the control loop for the first oscillation axis will be discussed below, although the explanations can also be applied to the control loop for the second oscillation axis.

A control variable in the control loop of FIG. 3 is the drive angular frequency ω_{drv,a} for driving the first oscillation around the first oscillation axis. At the beginning of the control, the reference angular frequency ω_{ref,a} is directly pre-controlled as the drive angular frequency ω_{drv,a} and initially determines ω_{drv,a} significantly. The control variable ω_{drv,a} is then integrated in a drive phase accumulator 305a to obtain a drive phase ω_{drv,a}. An electronic driver 310a generates therefrom an electronic drive signal for the drive (e.g., one or more piezo actuators) for the first oscillation, which may in particular be an oscillation about a first oscillation axis of a two-axis microscanner 315.

The actual phase position of the first oscillation is determined by means of a phase detection 320a. For this purpose, an actual phase of the first oscillation can be measured sensorily, in particular by means of one or more piezo sensors, and a phase difference signal φ_{sen,a} can be derived therefrom, which represents a phase difference between the measured actual phase and the drive phase φ_{drv,a}. From the drive phase φ_{drv,a}, an image phase φ_{im,a} (e.g. φ_{im,a}=φ_{drv,a}+φ_{sen,a}+C) is generated using the phase difference signal φ_{sen,a} and optionally a static correction value C with respect to the drive phase φ_{drv,a} to eliminate systematic measurement errors of the actual phase. This image phase φ_{im,a} is used in the example for image projection and pixel addressing within the framework of a projection of an electromagnetic beam into an observation field according to FIG. 1 in order to select the next pixel to be projected into the observation field in an image to be projected. By subtracting a dead time D, which occurs during image processing in an image processing unit 325a, from the image phase φ_{im,a}, an instantaneous (mechanical) phase φ_{mech,a} Of the first oscillation is obtained. The image phase φ_{im,a} thus leads the (mechanical) phase φ_{mech,a} by the dead time D, so that the image values for the image points (pixels) of the projection image to be displayed are retrieved from an image source, e.g. an image data memory, in such a timely manner depending on the image phase that their projection takes place after the dead time D has elapsed exactly when the microscanner system projects in the projection direction associated with the respective image point according to the (mechanical) phase φ_{mech,a}. This ensures that each pixel of the image to be projected is actually displayed at the intended location in the image projected into the field of observation.

This phase φ_{mech,a} is compared via a feedback loop with the reference phase φ_{ref,a} provided by the reference information source in order to determine a control difference e, which is then fed to a controller 330a, which can in particular be designed as a P-controller. The controller 330a generates an angular frequency shift as the control variable, which is added to the reference angular frequency ω_{ref,a} to obtain an adjusted value for the drive phase φ_{drv,a}. As long as a control difference exists, the control loop accelerates or decelerates the drive oscillation relative to the reference oscillation in order to bring both oscillations into phase. As soon as this control target is reached, the drive angular frequency ω_{drv,a} and the reference angular frequency ω_{ref,a} are again identical.

This applies accordingly to the control loop for the second oscillation axis “b”, which is only incompletely indicated in FIG. 3 by dashed arrows and the reference numerals 310b (electronic driver) and 320b (phase detection).

Depending on the design, a deflection element of the microscanner system, together with its suspension, can have the characteristics of a nonlinear Duffing oscillator or can be approximately well described by it. For comparison, FIG. 4 shows exemplary amplitude and phase responses 400 of a harmonic oscillator with a restoring force that is linearly dependent on the deflection (solid curves in FIG. 4), and of a Duffing oscillator (dashed curves in FIG. 4), each in the case of a forced oscillation driven with a drive angular frequency ω.

While the harmonic oscillator, as a function of the drive angular frequency ω, exhibits a stable amplitude curve with a maximum at a resonance or natural frequency ω₀ of the harmonic oscillator and a phase of −90° (=−π/2), the Duffing oscillator, however, exhibits an unstable region at a phase below −90° (=−π/2), in which the amplitude of the oscillation collapses abruptly. For this reason, an operating point with a phase slightly larger than −90°, e.g. at −80°, is usually chosen. There the amplitude is still large, but some distance from the unstable region is maintained.

FIG. 5 schematically shows another exemplary embodiment 500 of a signal flow diagram for an extended control with a combined trajectory following control and resonance following control for controlling a drive of a multi-axis microscanner system. This extended control loop is intended to ensure that both oscillations remain in their respective resonant angular frequency range so that (due to resonance) large amplitudes can be maintained. The resonant angular frequency range includes not only the value of a resonant angular frequency ω₀ itself, but also a surrounding angular frequency range in which the resonance occurs at least approximately (cf. amplitude response in FIG. 4). For example, the resonant angular frequency range (resonance range) can be defined by [0.96ω₀; 1.04ω₀].

The extended control loop has an additional feedback loop (shown in dotted lines). For this purpose, the lower phase value is first selected as the control variable (“MIN”) from the actual phases φ_{sen,a} and φ_{sen,b} determined for the two oscillations by means of the two phase detections 320a and 320b. In the case of a microscanner that can be described by a Duffing oscillator, this measured value is closer to the unstable region of the oscillation as shown in FIG. 4 and can therefore be called a “critical” value. This critical value is compared with a defined setpoint SP to determine a control deviation. A PID controller 335 then manipulates the repetition rate LPS of the Lissajous figure and thus the two reference angular frequencies ω_{ref,a} and ω_{ref,b} as a function of the control deviation and via a multiplier and subsequently the drive phases φ_{drv,a} and φ_{drv,b} via the phase control described above (for each oscillation. This ensures resonant operation of the oscillations. The spatial properties of the resulting trajectory (in particular the Lissajous figure) are preserved. It is simply run through at a slightly different speed.

In this way, a Lissajous figure previously selected using the setting parameters N, M and γ can be maintained. In particular, mesh size, position of the crossing points in the Lissajous figure and other properties can be ensured. This allows for a flicker-free and consistent image impression to be created during projection. For 3D sensing applications (e.g. in the sense of “structured light”), specific scan patterns can also be selected that can be kept stable in this way. When using image evaluations based on machine learning in such 3D sensing applications, the same Lissajous figure can be reliably used in a virtual projection simulation (especially in the context of a training process for machine learning) and in a projection in reality, thus simplifying the machine learning process, since the training space and the image evaluation in reality can be restricted to the predetermined same Lissajous figure (same setting parameters N, M and γ).

By selecting the lower value (“MIN”) from the actual phases φ_{sen,a} and φ_{sen,b} as the control variable, a high stability of the system is ensured.

Dynamically varying the repetition rate LPS enables resonant operation over a wide range of parameter fluctuations in the microscanner system. This allows operation within a wide temperature range, for example.

While at least one exemplary embodiment has been described above, it is to be noted that a large number of variations thereto exist. It is also to be noted that the exemplary embodiments described only represent non-limiting examples, and are not intended to restrict the scope, the applicability, or the configuration of the devices and methods described herein. Rather, the preceding description will provide those skilled in the art with guidance for implementing at least one exemplary embodiment, wherein it is apparent that various changes in the operation and arrangement of elements described in an exemplary embodiment may be made without departing from the scope of the subject matter defined in the appended claims and their legal equivalents.

### LIST OF REFERENCE NUMERALS

100 microscanner system
105 laser source
110a laser beam
110b reflected beam
115 object in the observation field
125 microscanner
125a deflection element (mirror)
130 trajectory, in particular Lissajous figure
135 device for controlling a drive of the microscanner system 100
200 reference information source, in particular its signal flow diagram
205 multiplication or multiplication unit
210 further multiplication or multiplication unit, for oscillation axis b
215 further multiplication or multiplication unit, for oscillation axis a
220 integration or integration unit, for oscillation axis b
225 integration or integration unit, for oscillation axis a
300 trajectory following control
305a drive phase accumulator
310a electronic driver for oscillation axis a
310b electronic driver for oscillation axis b
315 microscanner
320a phase detection for oscillation axis a
320b phase detection for oscillation axis b
325a image processing process or unit
330a controller
335 PID controller
400 amplitude and phase responses
500 trajectory following control with resonance follower
N individual setting parameter for oscillation axis b
M individual setting parameter for oscillation axis a
Y start phase setting parameter
LPS common setting parameter (especially factor) for both oscillations, determines trajectory repetition rate
C correction variable
D dead time
SP setpoint
ω_{ref,a} reference (angular) frequency for oscillation axis a
ω_{ref,b} reference (angular) frequency for oscillation axis b
φ_{ref,a} reference phase for oscillation axis a
φ_{ref,b} reference phase for oscillation axis b
ω_{drv,a} drive frequency for oscillation axis a
ω_{drv,b} drive frequency for oscillation axis b
φ_{drv,a} drive phase for oscillation axis a
φ_{drv,b} drive phase for oscillation axis b
φ_{sen,a} phase difference signal for oscillation axis a
φ_{sen,b} phase difference signal for oscillation axis b
φ_{mech,a} mechanical phase of the oscillation
φ_{im,a} image phase
ω drive circuit frequency
ω₀ resonance circuit frequency
δω deviation from the resonance circuit frequency ω₀ to define a resonance range

What is claimed is:

1. A method for controlling a drive of a multi-axis microscanner system having a first oscillation axis and a second oscillation axis running non-parallel thereto, the method comprising:
generating reference information defining a simultaneous reference oscillation about the first and second oscillation axes, such that the reference information for the first and second oscillation axes each defines an associated reference frequency and an associated reference phase of the reference oscillation;
controlling a drive device for the microscanner system in such a way that the drive device is caused
to drive a first rotational oscillation of a deflection element of the microscanner system about the first oscillation axis by means of an excitation at a first drive frequency, and
to drive a second rotational oscillation of a deflection element of the microscanner system carried out simultaneously with the first oscillation about the second oscillation axis by means of an excitation at a second drive frequency;
wherein the drive device is controlled in such a way that, with respect to each of the oscillations, its respective drive frequency and drive phase is/are varied over time by means of a controller in such a way that, with respect to the oscillation axis associated with the respective oscillation, a deviation of the respective oscillation in terms of frequency and phase from the reference oscillation is counteracted.

2. The method according to claim 1, wherein the control of the drive device takes place in such a way that the driving of the first oscillation is pre-controlled with the first reference frequency and/or the driving of the second oscillation is pre-controlled with the second reference frequency before the temporal variation of the respective drive frequency and drive phase of the respective oscillation takes place within the scope of the control.

3. The method according to claim 1, wherein for at least one oscillation axis, the temporal variation of the drive frequency and drive phase of the oscillation associated with this oscillation axis takes place within the scope of the control as a function of measurement information which represents a measured actual phase of the oscillation about this oscillation axis.

4. The method according to claim 3, wherein the temporal variation of the drive frequency and/or drive phase of the oscillation associated with this oscillation axis takes place within the scope of the control as a function of a phase difference between the actual phase of the oscillation represented by the measurement information and the corresponding phase of the reference oscillation with respect to the oscillation axis associated with the oscillation.

5. The method according to claim 3, furthermore including:
for the at least one oscillation axis, monitoring the phase difference between the drive phase and the actual phase of the oscillation associated with this oscillation axis; and
if, within the scope of monitoring, a change in the phase difference is detected for this oscillation axis, varying the respective drive frequencies for the first oscillation and the second oscillation within the scope of the control by raising or lowering them by a factor (LPS) that is the same for both oscillations, wherein the factor (LPS) is selected such that, with regard to the at least one oscillation axis, a migration of the angular frequency of the associated oscillation from a defined resonance range of the oscillation is counteracted.

6. The method according to claim 5, wherein the control is carried out in such a way that the factor is determined as a function of one of the following variables:
detected phase difference between the drive phase and the actual phase of only one previously selected oscillation;
mean value of the respective phase differences detected between the respective drive phase and the respective actual phase of the first oscillation on the one hand and the second oscillation on the other hand;
detected phase difference between the drive phase and the actual phase of only one of the oscillations, wherein this oscillation is dynamically selected from the two oscillations during control as the smaller of the phase differences of the last phase differences detected over time.

7. The method according to claim 1, wherein, within the scope of the control
in the steady state of the first oscillation, the first drive phase is limited so that it leads the measured actual phase of the first oscillation by less than 90°, in particular by 85° or less; and/or
in the steady state of the second oscillation, the second drive phase is limited so that it leads the measured actual phase of the second oscillation by less than 90°, in particular by 85° or less.

8. The method according to claim 1, wherein, within the scope of the control with respect to at least one of the oscillations, a correction variable defined via at least one adjustable parameter for the drive phase of the oscillation is included in the determination of a control variable of the control for this oscillation.

9. The method according to claim 1, wherein, within the scope of the control with respect to at least one of the oscillations, a phase shift dependent on a dead time of an image processing process for images to be imaged by means of the microscanner system is included in the determination of a control variable of the control for this oscillation.

10. A device, in particular an electrical circuit, for controlling a drive of a multi-axis microscanner system with a first oscillation axis and a second oscillation axis running non-parallel thereto, the device comprising:
a reference information source for generating reference information defining a simultaneous reference oscillation about the first and second oscillation axes, such that the reference information for the first and second oscillation axes each defines an associated reference frequency for the first and second oscillation axis respectively define an associated reference frequency and an associated reference phase of the reference oscillation;
a control device for generating control signals for controlling a drive device of the microscanner system in order to cause the microscanner system, by means of the drive device controlled by means of the control signals,
to drive a first rotational oscillation of a deflection element of the microscanner system about the first oscillation axis by means of an excitation at a first drive frequency, and
to drive a second rotational oscillation of a deflection element of the microscanner system carried out simultaneously with the first oscillation about the second oscillation axis by means of an excitation at a second drive frequency;
wherein the control device has a controller and is configured to generate the control signals in such a way that, with respect to each of the oscillations, their respective drive frequency and drive phase is/are varied over time by means of the controller in such a way that, with respect to the oscillation axis associated with the respective oscillation, a deviation of the respective oscillation in terms of frequency and phase from the reference oscillation is counteracted.

11. The device according to claim 10, wherein the reference information source is configured to determine the reference frequencies and the reference phases of the reference oscillation as a function of at least the following input variables:
a setting parameter common to both oscillation axes for setting a repetition rate of a Lissajous figure corresponding to the reference oscillation;
a first individual setting parameter associated with the first oscillation axis and a second individual setting parameter associated with the second oscillation axis, wherein the shape of the reference oscillation can be determined on the basis of the two individual setting parameters.

12. The device according to claim 11, wherein the reference information source is further configured to determine the reference frequencies and the reference phases of the reference oscillation additionally as a function of a start phase setting parameter as a further input variable, which defines a start phase for one of the two reference phases of the reference oscillation.

13. The device according to claim 10, wherein the controller comprises a control circuit for controlling the drive frequency and the drive phase of the first oscillation and a separate control circuit for controlling the drive frequency and the drive phase of the second oscillation.

14. The device according to claim 10, wherein the device further comprises the drive device.

15. The device ice according to claim 10, wherein the device is further configured to generate the control signals such that the drive device can be controlled therewith according to a method, wherein, in the method, the control of the device takes place in such a way that the driving of the first oscillation is pre-controlled with the first reference frequency and/or the driving of the second oscillation is pre-controlled the second reference frequency before the temporal variation of the respective frequency and drive phase of the respective oscillation takes place within the scope of the control.

16. A microscanner system for deflecting an electromagnetic beam comprising:
a multi-axis microscanner with two different non-parallel oscillation axes or a combination of several individual, in particular two, single-axis microscanners, which are arranged in such a way that the incident beam can be deflected successively by the different individual microscanners of the microscanner system in order to generate a Lissajous figure; and
the device according to claim 15 for controlling a drive of the microscanner system by the drive device.

17. The method according to claim 2, wherein for at least one oscillation axis, the temporal variation of the drive frequency and drive phase of the oscillation associated with this oscillation axis takes place within the scope of the control as a function of measurement information which represents a measured actual phase of the oscillation about this oscillation axis.

18. The method according to claim 4, furthermore including:
for the at least one oscillation axis, monitoring the phase difference between the drive phase and the actual phase of the oscillation associated with this oscillation axis; and
if, within the scope of monitoring, a change in the phase difference is detected for this oscillation axis, varying the respective drive frequencies for the first oscillation and the second oscillation within the scope of the control by raising or lowering them by a factor (LPS) that is the same for both oscillations, wherein the factor (LPS) is selected such that, with regard to the at least one oscillation axis, a migration of the angular frequency of the associated oscillation from a defined resonance range of the oscillation is counteracted

19. The method according to claim 2, wherein, within the scope of the control
in the steady state of the first oscillation, the first drive phase is limited so that it leads the measured actual phase of the first oscillation by less than 90°, in particular by 85° or less; and/or
in the steady state of the second oscillation, the second drive phase is limited so that it leads the measured actual phase of the second oscillation by less than 90°, in particular by 85° or less.

20. The method according to claim 2, wherein, within the scope of the control with respect to at least one of the oscillations, a correction variable defined via at least one adjustable parameter for the drive phase of the oscillation is included in the determination of a control variable of the control for this oscillation.
